(19) United States
(12) Patent Application Publication
(10) Pub. No.: US 2004/0181860 A1
(43) Pub. Date: Sep. 23, 2004

(54) Clothing with protective qualities

(76) Inventor: Kelly Forsyth-Gibson, Aberdeen (GB)

Correspondence Address: RATNERPRESTIA, P O BOX 980, VALLEY FORGE, PA, 19482-0980, US

(21) Appl. No.: 10/484,127

(22) PCT Filed: Jul. 11, 2002
(86) PCT No.: PCT/GB02/03190

(30) Foreign Application Priority Data
Jul. 16, 2001 (GB) 0117202.5

(51) Int. Cl. A62B 17/00; A41D 13/12

(52) U.S. Cl. 2/456

(57) ABSTRACT

This invention relates to items of clothing, in particular headwear, which has protective qualities. The protective clothing (1) is provided in a number of shock absorbent sections (2) which are joined together to make the basic structure. Air vents are provided in the form of either elastic material or slits (6), and one or more of the vents can be provided with an adjustable fastener (7) which allows the clothing to expand to fit.

This invention relates to items of clothing which also have protective properties, in particular to headwear with protective aspects.

There are a number of occasions when it would be beneficial to have clothing with additional protective features. For example, young children who are at the toddler stage are generally less than sure-footed but are at the same time very keen to run around, explore and make maximum use of their new found mobility. The inevitable result is that they tend to fall over or bump into things on a regular basis. For young children in particular the skull and fontanel are particularly vulnerable and, inevitably, it is the head which suffers from the effects of bumps and thumps. Indoors much can be done to provide protective edges to furniture and the like and outdoors in children's playgrounds soft ground materials provide a degree of protection. However in even the best protected environments there remains considerable opportunity for children to bump their heads against hard and/or sharp objects.

For slightly older children other risks arise from participation in various games and sporting activities. Some degree of protection is provided from, for example, cycle helmets but these are not generally suitable for general use particularly by small children. In all instances conventional protective head gear may be too unwieldy and have straps and fixings which may become a hazard themselves by virtue of easily catching on obstructions.

Also, for adults when playing sports or taking part in activities such as orienteering, skiing, snowboarding or cycling, there are many occasions when injuries may occur. Only a few sports have specific items of protective clothing associated with them, and these are usually only suitable to be worn when taking part in the activity.

While there have been protective helmets described in the prior art, these protective helmets tend to be uncomfortable, bulky and are not visually appealing, and in all cases in the prior art, protective clothing is purely functional and cannot be worn as everyday clothing.

It is an object of the present invention to provide an item of shock absorbent headwear which is both comfortable to wear and visually attractive.

It is a further object of the present invention to provide an item of clothing that can be worn as everyday apparel, and which also has protective qualities.

According to the present invention there is provided protective clothing, wherein the clothing comprises panels of a shock absorbent material which are joined together to form the shape of the clothing.

Preferably, the clothing takes the form of headwear.

Preferably, each shock absorbent panel is provided with a flexible prong along the edge of the panel which provides support to the structure of the clothing.

Preferably, each shock absorbent panel is provided with an indentation running along the edge to allow the flexible prong to be inserted into the panel.

Preferably, between each shock absorbent panel there is provided an air vent which allows air to flow through the clothing.

Preferably, the air vent takes the form of an elasticated material which is able to allow air to flow through it.

Optionally the panels of shock absorbent material have a rigid outer coating panel.

Preferably the rigid outer coating panel is adhesively attached to each panel of shock absorbent material.

Preferably, the shock absorbent headwear is provided with a material tie on the lower rim of the headwear, so that the headwear may be firmly secured to the wearer's head.

Preferably, the ties are adjustable so that the headwear can be tightened or loosened, depending on the size of the wearer's head.

Preferably, the inside of the protective clothing is provided with a lining.

Most preferably, the lining comprises a breathable material.

Most preferably, the lining is of greater surface area than the surface area of the inner side of the protective clothing to allow the lining to move in the case of impact, so not to cause friction.

Preferably, the inside of the headwear is provided with a sweatband.

Preferably, this sweatband is fixed to the inside of the cap in a removable manner.

Most preferably, the sweatband is fixed to the inside of the cap using Velcro® or hook and loop fasteners.

Preferably, the sweatband is provided in a machine washable material.

Optionally, the shock absorbent headwear may be provided with a peak.

Preferably, the peak is removable.

Optionally, the shock absorbent headwear may be provided with a sun visor.

Preferably, the sun visor is removable.

Optionally, the shock absorbent headwear may be provided with a chin strap.

Preferably, the chin strap may be fastened using a Velcro® strap.

Optionally, the chin strap is removable.

Optionally, the shock absorbent headwear may be provided with slits running from the lower rim of the headwear, up towards the crown of the headwear. This would allow the cap to expand to fit different head sizes.

Preferably, the slits are provided with adjustable fastenings which allow the size of the headwear to be adjusted according to the size of the wearer's head and then held at that required size.

Optionally, the shock absorbent headwear may incorporate external design features, for example extra material may be added to represent ears and eyes, so that the headwear is more visually attractive to the wearer.

An embodiment of the present invention will be now be described by way of example only, and with reference to the accompanying drawings, in which:

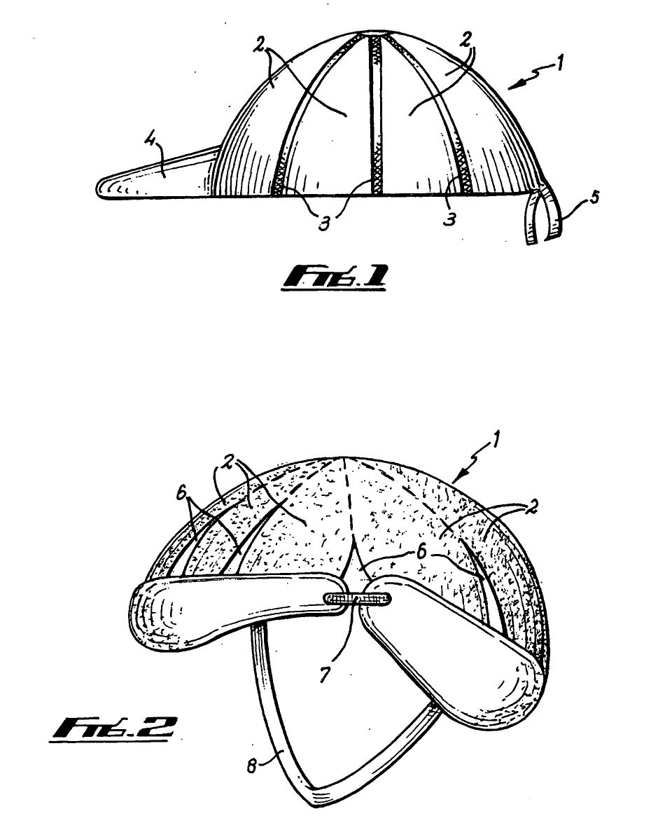

FIG. 1 is a side view of a shock absorbent item of headwear, according to one embodiment of this invention;

FIG. 2 is a side view of a shock absorbent item of headwear, according to a further embodiment of this invention;

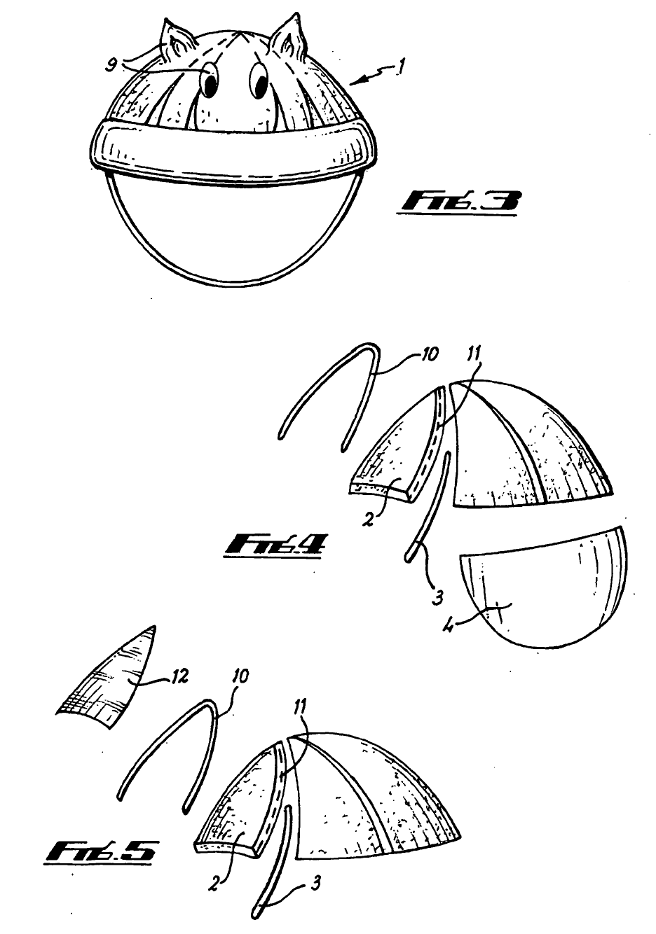

FIG. 3 shows a front view of a shock absorbent item of headwear according to this invention, which incorporates additional design features;

FIG. 4 shows an exploded view of a shock absorbent item of headwear, according to this invention; and

FIG. 5 shows an exploded view of a shock absorbent item of headwear according to this invention, where the headwear has additional rigid material on the outer surface.

Referring to FIG. 1 and FIG. 2, the drawings show two different embodiments of the present invention. FIG. 1 shows protective headgear 1 in the form of a cap. The cap is produced from a number of shock absorbent panels 2, which have air vents 3 between each panel 2. This provides the basis structure of the shock absorbent headwear 1. Additionally, there is provided a cap peak 4 which may be attached to the front of the shock absorbent headwear 1, if required. There is also an adjustable tie 5 provided which allows the circumference of the cap to be reduced depending on the size of the wearer's head. It is also possible to provide an elasticated stretch band around the rim of the circumference of the headwear, which allows for different sized heads. The air vents 3 between each panel 2 can also be in the form of an elasticated material with built-in ventilation.

The FIG. 2 embodiment also shows the basic structure of the shock absorbent headwear 1 in that there are a number of shock absorbent sections 2 which preferably are made of foam, that are joined together to make the basic structure. In this case rather than the air vents being provided as elastic material, the vents are provided as slits 6, moving from the base of the headwear up towards the crown of the headwear. In this case, one of the slits 6 is provided with an adjustable velcro fastener 7 which can be adjusted to allow the slit 6 to be opened further or to be closed, depending on the size of the wearer's head. The shock absorbent headwear 1 is also provided with a chin strap 8, so that the shock absorbent headwear 1 can be firmly secured to the wearer's head.

It can be seen that both of the embodiments of the invention are both visually attractive and comfortable to wear. FIG. 3 shows how the shock absorbent headwear 1 can be made to appear more appealing to the wearer by the use of external design features 9.

The shape of the shock absorbent headwear 1 is reinforced by the insertion of a flexible prong 10 into the shock absorbent panels 2. In order to ensure that the flexible prong, which is usually made of a plastic material, will never make contact with the skin and an indentation 11 is provided on the edge of each shock absorbent panel 2 so that the flexible prong 10 can be inserted and be completely surrounded by the shock absorbent material.

The headwear, which usually takes the form of a cap, can also be provided with an inner lining made of a breathable material which is exaggerated in size so that it is able to move in the case of an impact, so as not to cause a friction injury on the scalp.

A further embodiment, as shown in FIG. 5, allows the shock absorbent headwear 1 to be used for more vigorous activities.

The shock absorbent panels 2 have a rigid panel 12 attached to the external surfaces. This has the benefit of strengthening the shock absorbent headwear 1 while retaining the ability to fit each wearer precisely due to its expandable nature. There is an added benefit in that if a rigid panel is damaged during use, only that panel must be replaced, rather than the entire product.

The benefits of this invention are many-fold. The invention is such that a one-size product can be worn by users of different sizes, there is built-in ventilation for comfort and when looking at headwear, the use of a chin strap can be avoided entirely, removing the possibility of strangulation.

It can be seen that additional modifications and improvements are possible without departing from the scope of the invention herein intended, and the abovementioned examples should not be considered limiting.

1. Protective clothing, wherein the clothing comprises panels of a shock absorbent material which are joined together to form the shape of the clothing.

2. Protective clothing as claimed in claim 1, wherein the clothing takes the form of headwear.

3. Protective clothing as claimed in claims 1 or 2, wherein each shock absorbent panel is provided with a flexible prong along the edge of the panel which provides support to the structure of the clothing.

4. Protective clothing as claimed in any of the previous claims, wherein each shock absorbent panel is provided with an indentation running along the edge to allow the flexible prong to be inserted into the panel.

5. Protective clothing as claimed in any of the previous claims, wherein between each shock absorbent panel there is provided an air vent which allows air to flow through the clothing.

6. Protective clothing as claimed in claim 5, wherein the air vent takes the form of an elasticated material which is able to allow air to flow through it.

7. Protective clothing as claimed in any of the previous claims, wherein the panels of shock absorbent material have a rigid outer coating panel.

8. Protective clothing as claimed in claim 7, wherein the rigid outer coating panel is adhesively attached to each panel of shock absorbent material.

9. Protective clothing as claimed in any of claims 2 to 8, wherein the shock absorbent headwear is provided with a material tie on the lower rim of the headwear, so that the headwear may be firmly secured to the wearer's head.

10. Protective clothing as claimed in claim 9, wherein the ties are adjustable so that the headwear can be tightened or loosened, depending on the size of the wearer's head.

11. Protective clothing as described in any of the previous claims, wherein the inside of the protective clothing is provided with a lining.

12. Protective clothing as described in claim 11, wherein the lining comprises a breathable material.

13. Protective clothing as claimed in claims 11 or 12, wherein the lining is of greater surface area than the surface area of the inner side of the protective clothing to allow the lining to move in the case of impact, so not to cause friction on the wearer.

14. Protective clothing as claimed in claims 2 to 13, wherein the inside of the headwear is provided with a sweatband.

15. Protective clothing as described in claim 14, wherein the sweatband is fixed to the inside of the cap in a removable manner.

16. Protective clothing as claimed in claims 14 or 15, wherein the sweatband is fixed to the inside of the cap using Velcro® or hook and loop fasteners.

17. Protective clothing as claimed in claims 2 to 16, wherein the shock absorbent headwear may be provided with a peak.

18. Protective clothing as claimed in claims 2 to 16, wherein the shock absorbent headwear may be provided with a sun visor.

19. Protective clothing, as claimed in claims 2 to 18, wherein the shock absorbent headwear may be provided with an elasticated band around the circumference.

20. Shock absorbent clothing as claimed in claims 2 to 19, wherein the shock absorbent headwear may be provided with slits running from the lower rim of the headwear, up towards the crown of the headwear to allow the cap to expand to fit different head sizes.

21. Protective clothing as described in claim 20, wherein the slits are provided with adjustable fastenings allowing the size of the headwear to be adjusted according to the size of the wearer's head, and then held at that required size.
